(19) United States
(12) Patent Application Publication
(10) Pub. No.: US 2014/0192863 A1
(43) Pub. Date: Jul. 10, 2014

(54) PERCEPTUAL LOSSLESS COMPRESSION OF IMAGE DATA FOR TRANSMISSION ON UNCOMPRESSED VIDEO INTERCONNECTS

(71) Applicants: Sreenath Kurupati, Sunnyvale, CA (US); C. Brendan S. Traw, Portland, OR (US)

(72) Inventors: Sreenath Kurupati, Sunnyvale, CA (US); C. Brendan S. Traw, Portland, OR (US)

(21) Appl. No.: 13/997,084

(22) PCT Filed: Dec. 21, 2011
(86) PCT No.: PCT/US11/66554

§ 371 Date: Mar. 31, 2014

(51) Int. Cl. H04N 19/124; H04N 19/50; H04N 19/182

(52) U.S. Cl. CPC H04N 19/0009; H04N 19/00303; H04N 19/00569
USPC 375/240.03

(57) ABSTRACT

Methods and systems may include a transmit apparatus and a receive apparatus. The transmit apparatus can have a first uncompressed video interconnect and an image encoder to generate a compressed bit stream based on an input pixel signal. The image encoder may also send the compressed bit stream to the first uncompressed video interconnect. The receive apparatus may have a second uncompressed video interconnect and an image decoder to receive the compressed bit stream from the second uncompressed video interconnect. The image decoder may also generate an output pixel signal based on the compressed bit stream.

### BACKGROUND

Video resolutions and frame rates may be increasing each year at a fairly dramatic pace. For instance, resolutions may be transitioning from SD (standard definition, e.g., 480p) to HD (high definition, e.g., 1080p) to quadHD (e.g., 4 k×2 k), and frame rates may be transitioning from 60 Hz to 120 Hz to 240 Hz. In addition, there may be an increasing demand for increased color bit precision (e.g., deep color) in display-enabled platforms. These conditions may be placing a heavy load on uncompressed video interconnects such as HDMI (High-Definition Multimedia Interface, e.g., HDMI Specification, Ver. 1.3a, Nov. 10, 2006, HDMI Licensing, LLC), component, and LVDS (Low Voltage Differential Signaling, e.g., TIA/EIA-644-A Electrical Characteristics of Low Voltage Differential Signaling (LVDS) Interface Circuits, Feb. 1, 2001, Telecommunications Industry Association) interconnects. In particular, due to electrical and cost issues, these interconnects could be lagging behind in implementing increased frame rates and/or resolutions. For example, conventional HDMI solutions might currently lack support for quadHD resolution at 60 Hz.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of an uncompressed video interface between a transmitting device and a receiving device according to an embodiment;

FIG. 2 is a flowchart of an example of a method of transmitting compressed video to an uncompressed video interconnect according to an embodiment;

FIG. 3 is a flowchart of an example of a method of receiving compressed video from an uncompressed video interconnect according to an embodiment;

FIG. 4 is a block diagram of an example of a computing platform according to an embodiment;

FIG. 5 is a block diagram of an example of a system having a navigation controller according to an embodiment; and

FIG. 6 is a block diagram of an example of a system having a small form factor according to an embodiment.

### DETAILED DESCRIPTION

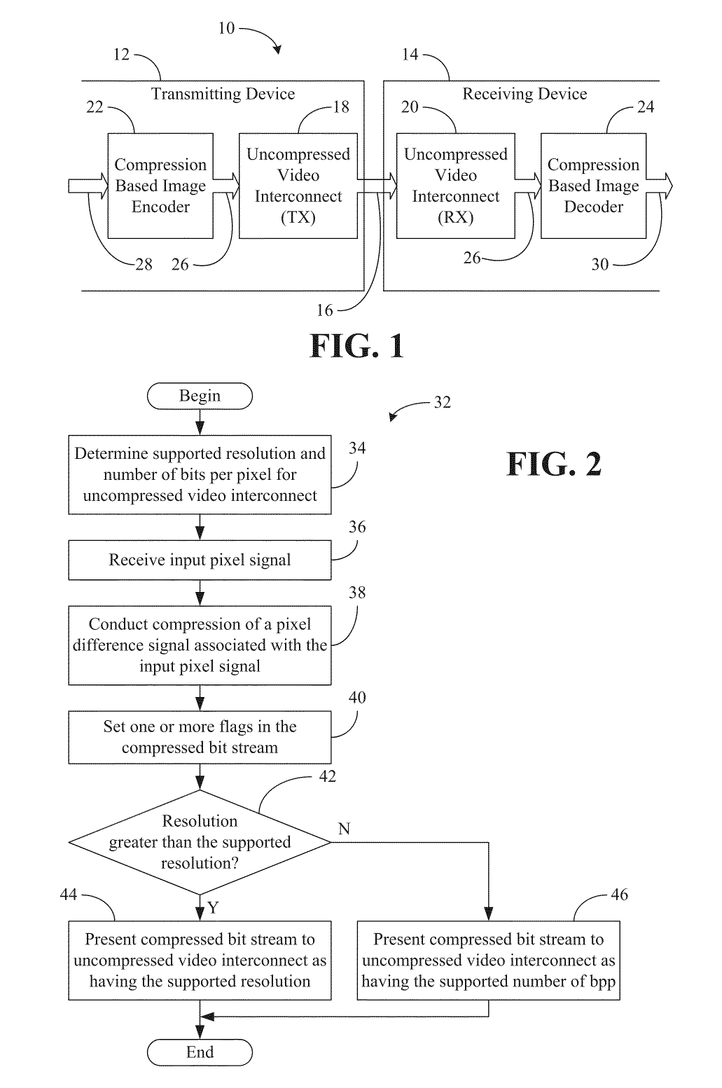

Turning now to FIG. 1, a video interface 10 between a transmitting device 12 and a receiving device 14 is shown. The transmitting device 12 could be a high resolution video source such as a Blu-ray disc player, an HD receiver, and so forth, and the receiving device 14 could be an appropriate display device such as an LCD (liquid crystal display), LED (light emitting diode) display, touch screen, and so forth. In the illustrated example, the devices 12, 14, are coupled to one another via uncompressed video interconnects 18, 20, and an uncompressed video medium (e.g., cable) 16 such as, for example, an HDMI, component, LVDS, V-by-One (e.g., V-by-One® HS Standard, Ver. 1.3, Jul. 7, 2010, THine Electronics, Inc.), or iDP (Internal DisplayPort, e.g., IDP Standard Ver. 1.0, April 2010, VESA) cable. The interconnects 18, 20 and medium 16 may be considered uncompressed in that they do not traditionally support the transfer of compressed video due to concerns over non-deterministic bits per pixel (bpp) reduction, latency variability (e.g., encoding and decoding), cost and quality. The illustrated interface 10, however, uses a compression based image encoder 22 and a compression based image decoder 24 to obviate each of these concerns.

In particular, the image encoder 22 may generate a compressed bit stream 26 based on an input pixel signal 28, and send the compressed bit stream 26 to the uncompressed video interconnect 18 for transmission to the uncompressed video interconnect 20 via the medium 16. In addition, the image decoder 24 may receive the compressed bit stream 26 from the uncompressed video interconnect 20 and generate an output pixel signal 30 based on the compressed bit stream 26. As will be discussed in greater detail, the illustrated compressed bit stream 26 has guaranteed and deterministic bits per pixel reduction, and fixed encode and decode latency. Additionally, the interface 10 may be a low cost solution that provides no perceptual quality loss in the output pixel signal 30.

FIG. 2 shows a method 32 of transmitting compressed video to an uncompressed video interconnect. The method 32 may be implemented in a compression based image encoder such as the image encoder 22 (FIG. 1) as a set of executable logic instructions stored in a machine- or computer-readable storage medium such as random access memory (RAM), read only memory (ROM), programmable ROM (PROM), flash memory, firmware, etc., in configurable logic such as programmable logic arrays (PLAs), field programmable gate arrays (FPGAs), complex programmable logic devices (CPLDs), in fixed-functionality hardware using circuit technology such as application specific integrated circuit (ASIC), complementary metal oxide semiconductor (CMOS) or transistor-transistor logic (TTL) technology, or any combination thereof. For example, computer program code to carry out operations shown in the method 32 may be written in any combination of one or more programming languages, including an object oriented programming language such as C++ or the like and conventional procedural programming languages, such as the “C” programming language or similar programming languages. Moreover, various aspects of the method 32 could be implemented as embedded logic of a graphics processor using any of the aforementioned circuit technologies.

Illustrated processing block 34 provides for determining a supported resolution and number of bits per pixel for the uncompressed video interconnect. In this regard, certain interconnects such as HDMI interconnects, might support specific resolutions (e.g., 1920×1080 pixels) as well as specific numbers of bits per pixel (e.g., 8 bpp, 10 bpp, 12 bpp, 16 bpp). Thus, block 34 could involve determining the particular configuration of the uncompressed video interconnect in question, wherein the determination may involve accessing an appropriate table/register, querying the uncompressed video interconnect, etc., either offline or in real-time. An input pixel signal may be received at block 36, wherein illustrated block 38 conducts a compression of a pixel difference signal associated with the input pixel signal.

For example, the input pixel signal may be associated with image and/or video content, wherein the input pixel signal might contain RGB (red/green/blue) raw data, YCbCr (lumina, chroma blue-difference, chroma red-difference) raw data, and so forth. In one example, a pixel difference module generates a pixel difference signal based on the input pixel signal and a pixel prediction signal, wherein the pixel difference signal can identify the difference between each pixel in the input pixel signal and a prediction of the pixel in question. Moreover, the pixel difference signal may be compressed in a perceptually lossless fashion.

In particular, a pixel prediction module may use a reference signal to predict pixel values for the pixels in an image, wherein the predictions can take into consideration related pixels. For example, the pixel prediction module might evaluate a combination of spatially and temporally adjacent pixels to predict the value of a pixel under consideration. Thus, the pixel difference module can compare each pixel to its prediction and output the pixel difference signal based on the comparison, wherein the pixel difference signal identifies the difference between a current pixel and a prediction of the current pixel. A compression module can be configured to receive the pixel difference signal, conduct a compression of the pixel difference signal based on the value of the pixel difference signal, and generate a modified pixel difference signal based on the compression, wherein a compressed bit stream such as the compressed bit stream 26 (FIG. 1) may in turn be generated based on the modified pixel difference signal.

With specific regard to the compression process, a determination may be made as to whether the value of the pixel difference signal is below a certain threshold. For example, if the pixel difference signal contains an 8-bit difference value (e.g., red difference, green difference, blue difference) ranging from 0-255, a threshold of sixteen might be used. If the value of the pixel difference signal is below the threshold, one or more most significant bits (MSBs) of the pixel difference signal can be discarded. Thus, in the example of an 8-bit difference value, the four MSBs (e.g., bits [7:4]) might be discarded. In this regard, no information is lost because the higher bits in the pixel difference signal would be zero if the value of the pixel difference signal is below the threshold.

If, on the other hand, it is determined that the pixel difference value is not below the threshold, one or more least significant bits (LSBs) in the pixel difference signal may be discarded. Thus, in the example of an 8-bit difference value, the four LSBs (e.g., bits [3:0]) could be discarded. Of particular note is that if the pixel difference value is relatively high, the visual difference between the current pixel and its related pixels may also be relatively high. For example, a high pixel difference value may be indicative of an edge (e.g., abrupt color and/or intensity transition) in the image at the pixel location, wherein the abrupt transition can far outweigh any minor differences in color/intensity from a visual standpoint. Thus, an edge transition from a shade of red to a shade of blue could be coded as an edge transition from pure red to pure blue (e.g., by discarding LSBs) without causing a perceptual loss of content/quality in the image. Accordingly, although the discarded bits may contain some information, the lost information is not likely to be perceivable to the human eye. Simply put, when surrounding pixels do not have the same intensity level of the pixel in question, the human eye cannot accurately estimate precise intensity and no perceptual loss is encountered when discarding LSBs.

As already noted, a modified pixel difference signal may be generated based on the compression, wherein the modified pixel difference signal will always be compressed. Moreover, the illustrated approach can achieve such guaranteed compression without encountering perceptual losses.

Other implementations may also be used depending upon the circumstances. For example, the pseudo code below might be deployed for a scenario in which one or more flag bits are used to embed the compression configuration into the modified pixel difference signal and 50% compression is a criterion.

===============
Encoding 8-bit to 4-bit example

delta[8:0] = input_val[7:0] − pred_val[7:0]; // the extra bit is for
negative delta
if (abs(delta[8:0]) > 20) {

enc_val[3] = 1; // quantization flag
enc_val[2:0] = input_val[7:5]; //quantization

}
else {

enc_val[3] = 0 ; // not quantized
if (delta[8:0] < 0) enc_val[2] = 1; // sign bit

else enc_val[2]= 0;
abs_delta[7:0] = abs(delta[8:0]);
if (abs_delta[7:0] ==0) enc_val[1:0] = 0; // 0
else if (abs_delta[7:0] <=2) enc_val[1:0] = 1; // 1,2
else if (abs_delta[7:0] <=7) enc_val[1:0] = 2;
else if (abs_delta[7:0] <20) enc_val[1:0] = 3;

}

================
Decoding 4-bit to 8-bit example

if (enc_val[3] == 1) { // value was quantized during encoding

Decoded_val = enc_val[2:0]*32 + 16;

}
else {

if (enc_val[1:0]==0) dec_delta = 0;
else if (enc_val[1:0]==1) dec_delta = 1;
else if (enc_val[1:0]==2) dec_delta= 4;
else if (enc_val[1:0]==3) dec_delta = 11;
if (enc_val[2]==1) dec_delta = 0-dec_delta; // negative delta

decoded_val = pred_val + dec_delta;
}

================
Encoding 10-bit to 5-bit example

delta[10:0] = input_val[9:0] − pred_val[9:0]; // the extra bit is for
negative delta
if (abs(delta[10:0]) > 64) {

enc_val[4] = 1; // quantization flag
enc_val[3:0] = input_val[9:6]; //quantization

}
else {

enc_val[4] = 0 ; // not quantized
if (delta[10:0] < 0) enc_val[3] = 1; // sign bit
else enc_val[3]= 0;
abs_delta[9:0] = abs(delta[10:0]);
if (abs_delta [9:0]==0) enc_val[2:0] = 0;
else if (abs_delta [9:0]==1) enc_val[1:0] = 1;
else if (abs_delta [9:0]==2) enc_val[1:0] = 2;
else if (abs_delta [9:0]==3) enc_val[1:0] = 3;
else if (abs_delta [9:0]==7) enc_val[1:0] = 4;
else if (abs_delta [9:0] <= 19) enc_val[1:0] = 5;
else if (abs_delta [9:0] <= 39) enc_val[1:0] = 6;
else if (abs_delta [9:0] <= 63) enc_val[1:0] = 7;

}

================
Decoding 5-bit to 10-bit example

if (enc_val[4] == 1) { // value was quantized during encoding

decoded_val = enc_val[3:0]*64 + 32;

}
else {

if (enc_val[2:0]==0) dec_delta = 0;
else if (enc_val[2:0]==1) dec_delta = 1;
else if (enc_val[2:0]==2) dec_delta= 2;
else if (enc_val[2:0]==3) dec_delta = 3;
else if (enc_val[2:0]==4) dec_delta = 4;
else if (enc_val[2:0]==5) dec_delta= 12;
else if (enc_val[2:0]==6) dec_delta = 28;
else if (enc_val[2:0]==7) dec_delta = 52;
if (enc_val[3]==1) dec_delta = 0-dec_delta; // negative delta
decoded_val = pred_val + dec_delta;

}

================

In addition, adaptivity based on previous pixel encoding may be implemented. For example, the pseudo code below might be deployed for the 8-bit to 4-bit encoding example.

if (prev_enc_pxl[3] ==1) {

// quantize without a flag
Enc_val[3:0] = input_val[7:4];

}
else {
// Else clause code below is identical to initial 8b to 4b example.
delta[8:0] = input_val[7:0] − pred_val[7:0]; // the extra bit is for
negative delta
if (abs(delta[8:0]) > 20) {

enc_val[3] = 1; // quantization flag
enc_val[2:0] = input_val[7:5]; //quantization

}
else {

enc_val[3] = 0 ; // not quantized
if (delta[8:0] < 0) enc_val[2] = 1; // sign bit
else enc_val[2]= 0;
abs_delta[7:0] = abs(delta[8:0]);
if (abs_delta[7:0] ==0) enc_val[1:0] = 0; // 0
else if (abs_delta[7:0] <=2) enc_val[1:0] = 1; // 1,2
else if (abs_delta[7:0] <=7) enc_val[1:0] = 2;
else if (abs_delta[7:0] <20) enc_val[1:0] = 3;

}

Thus, a guaranteed and deterministic level of compression may be achieved. Illustrated block 40 provides for setting one or more flag bits in the compressed bit stream (e.g., as indicated in the pseudo code above) based on the compression. A determination may also be made at block 42 as to whether the resolution of the input pixel signal is greater than a supported resolution of the uncompressed video interconnect. If so, the compressed bit stream may be presented to the uncompressed video interconnect at block 44 as having the supported resolution. For example, an input pixel stream having a resolution of 3840×1080 pixels might be presented to the uncompressed video interconnect as having a resolution of 1920×1080 pixels so long as that is a supported resolution of the uncompressed video interconnect. In such a case, two pixels of ten bits each might be packed into two pixels of five bits each, wherein the input pixel signal may have a number of bits per pixel that equals a supported number of bits per pixel of the uncompressed video interconnect.

If, on the other hand, it is determined at block 42 that the resolution of the input pixel signal is not greater than a supported resolution, block 46 may present the compressed bit stream to the uncompressed video interconnect as having a supported number of bits per pixel even though the input pixel signal may have a higher number of bits per pixel. For example, a 1920×1080 input pixel stream might have sixteen bits per pixel prior to compression, whereas the compression process would enable the compressed bit stream to be presented to the uncompressed video interconnect as an 8 bpp raw video signal (at the supported resolution of 1920×1080 pixels).

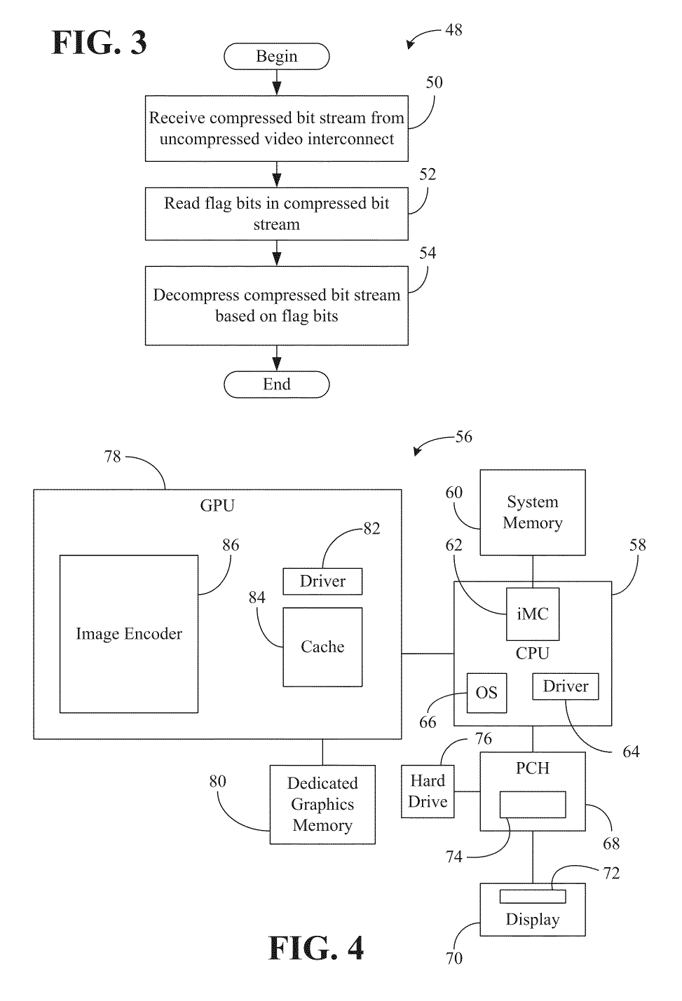

FIG. 3 shows a method 48 of receiving compressed video. The method 48 may be implemented in a compression based image encoder such as the image encoder 24 (FIG. 1) as a set of executable logic instructions stored in a machine- or computer-readable storage medium such as RAM, ROM, PROM, flash memory, firmware, etc., in configurable logic such as PLAs, FPGAs, CPLDs, in fixed-functionality hardware using circuit technology such as ASIC, CMOS or TTL technology, or any combination thereof. For example, computer program code to carry out operations shown in the method 48 may be written in any combination of one or more programming languages, including an object oriented programming language such as C++ or the like and conventional procedural programming languages, such as the “C” programming language or similar programming languages. Moreover, various aspects of the method 48 could be implemented as embedded logic of a display controller using any of the aforementioned circuit technologies.

Illustrated processing block 50 provides for receiving a compressed bit stream from an uncompressed video interconnect, wherein one or more flag bits in the compressed bit stream may be read at block 52. Block 54 may decompress the compressed bit stream based on the flag bits. In particular, the decompression process could involve establishing a resolution for the output pixel signal that is greater than a supported resolution of the uncompressed video interconnect, while the number of bits per pixel of the output pixel signal may be equal to a supported number of bits per pixel of the uncompressed video interconnect. Similarly, the decompression process could involve establishing a number of bits per pixel for the output pixel signal that is greater than a supported number of bits per pixel of the uncompressed video interconnect, while the resolution of the output pixel signal may be equal to a supported resolution of the uncompressed video interconnect.

Turning now to FIG, 4, a platform 56 is shown, wherein the platform 56 may be a mobile platform such as a laptop, mobile Internet device (MID), personal digital assistant (PDA), media player, imaging device, etc., any smart device such as a smart phone, smart tablet and so forth, or any combination thereof. The platform 56 may also be a fixed platform such as a personal computer (PC), server, workstation, smart TV, etc. The illustrated platform 56 includes a central processing unit (CPU, e,g., main processor) 58 with an integrated memory controller (iMC) 62 that provides access to system memory 60, which could include, for example, double data rate (DDR) synchronous dynamic RAM (SDRAM, e.g., DDR3 SDRAM JEDEC Standard JESD79-3C, April 2008) modules. The modules of the system memory 60 may be incorporated, for example, into a single inline memory module (SIMM), dual inline memory module (DIMM), small outline DIMM (SODIMM), and so on. The CPU 58 may also have one or more drivers 64 and/or processor cores (not shown), where each core may be fully functional with instruction fetch units, instruction decoders, level one (L1) cache, execution units, and so on. The CPU 58 could alternatively communicate with an off-chip variation of the iMC 62, also known as a Northbridge, via a front side bus or a point-to-point fabric that interconnects each of the components in the platform 56. The CPU 58 may also execute an operating system (OS) 66 such as a Microsoft Windows, Linux, or Mac (Macintosh) OS.

The illustrated CPU 58 communicates with a platform controller hub (PCH) 68, also known as a Southbridge, via a hub bus. The iMC 62/CPU 58 and the PCH 68 are sometimes referred to as a chipset. The CPU 58 may also be operatively connected to a network (not shown) via a network port (not shown) through the PCH 68. A display 70 (e.g., touch screen, LCD, LED display) could also have an uncompressed video interconnect 72 that communicates with an uncompressed video interconnect 74 of the PCH 68 in order to allow a user to view images and/or video from the platform 56. Thus, the interconnect 74 may be similar to the interconnect 18 (FIG. 1), and the interconnect 72 may be similar to the interconnect 20 (FIG. 1), already discussed. The illustrated PCH 58 is also coupled to storage, which may include a hard drive 76, ROM, optical disk, flash memory (not shown), etc.

The illustrated platform 56 also includes a dedicated graphics processing unit (GPU) 78 coupled to a dedicated graphics memory 80. The dedicated graphics memory 80 could include, for example, GDDR (graphics DDR) or DDR SDRAM modules, or any other memory technology suitable for supporting graphics rendering. The GPU 78 and graphics memory 80 might be installed on a graphics/video card, wherein the CPU 78 could communicate with the CPU 58 via a graphics bus such as a PCI Express Graphics (PEG, e.g., Peripheral Components Interconnect/PCI Express x16 Graphics 150W-ATX Specification 1.0, PCI Special Interest Group) bus, or Accelerated Graphics Port (e.g., AGP V3.0 Interface Specification, September 2002) bus. The graphics card may be integrated onto the system motherboard, into the main CPU 58 die, configured as a discrete card on the motherboard, etc. The GPU 78 may also execute one or more drivers 82, and may include an internal cache 84 to store instructions and other data.

The illustrated GPU 78 includes an image encoder 86 such as the image encoder 22 (FIG. 1), already discussed. Thus, the image encoder 86 may be configured to compress a pixel difference signal associated with an input image signal based on the value of the pixel difference signal, generate an encoded bit stream based on the compressed pixel difference signal, and send the compressed bit stream to the display 70 via the uncompressed video interconnects 74, 72. The display 70 may also include an image decoder (not shown) such as the image decoder 24, already discussed.

Embodiments may therefore include a transmit apparatus having an uncompressed video interconnect and an image encoder. The image encoder may be configured to generate a compressed bit stream based on an input pixel signal, and send the compressed bit stream to the uncompressed video interconnect.

Embodiments can also include a computer readable storage medium having a set of instructions which, if executed by a processor, cause a computer to generate a compressed bit stream based on an input pixel signal. The instructions may also cause a computer to send the compressed bit stream to an uncompressed video interconnect.

In addition, embodiments may include a receive apparatus having an uncompressed video interconnect, and an image decoder. The image decoder may be configured to receive a compressed bit stream from the uncompressed video interconnect, and generate an output pixel signal based on the compressed bit stream.

Other embodiments can include a computer readable storage medium having a set of instructions which, if executed by a processor, cause a computer to receive a compressed bit stream from an uncompressed video interconnect. The instructions may also cause a computer to generate an output pixel signal based on the compressed bit stream.

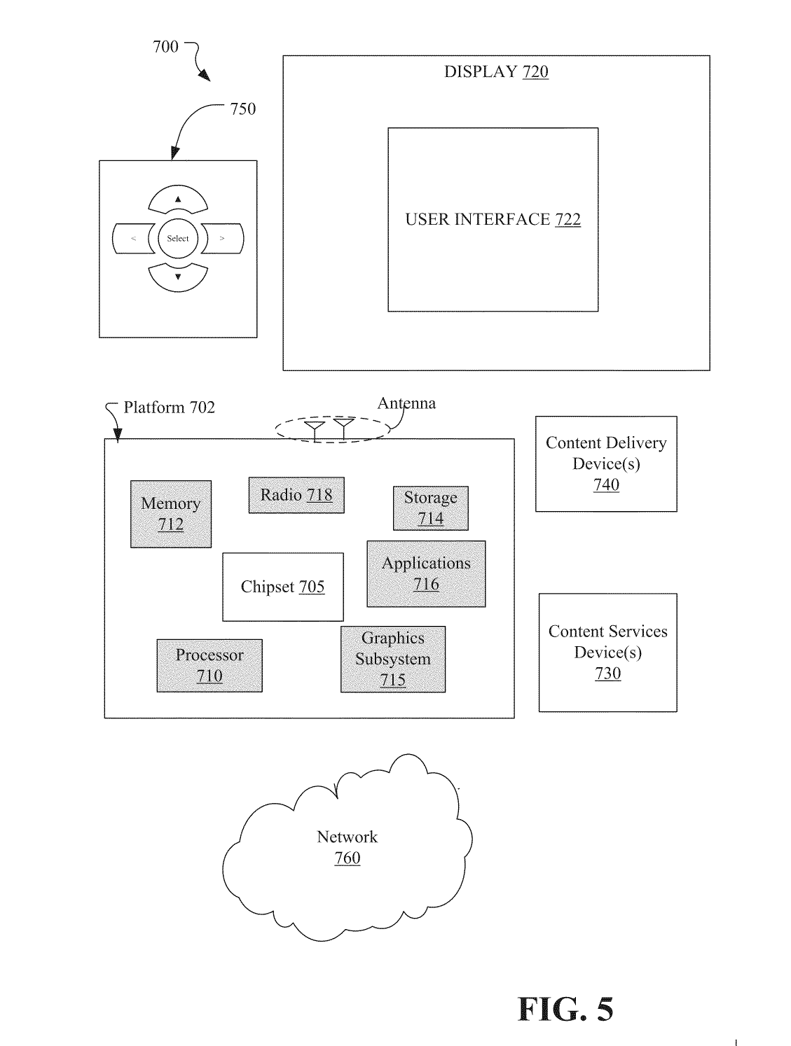

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, fitters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, to and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

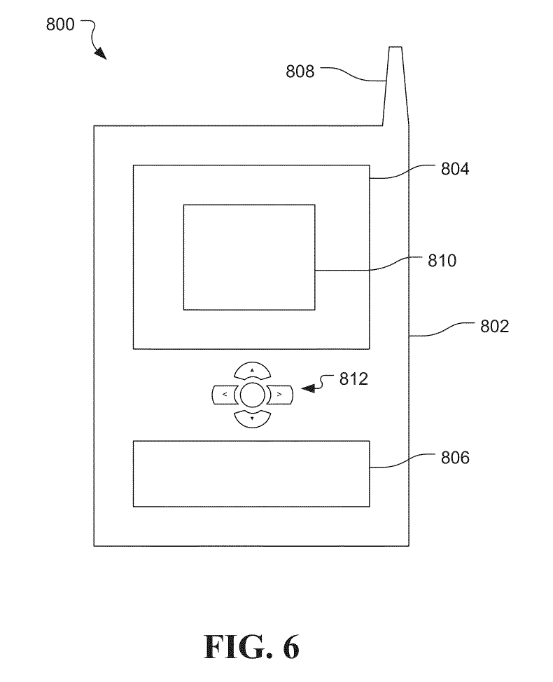

As described above, system 700 may be embodied in varying physical styles or form factors. FIG. 6 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewritable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A transmit apparatus comprising:
an uncompressed video interconnect; and
an image encoder to,
generate a compressed bit stream based on an input pixel signal, and
send the compressed bit stream to the uncompressed video interconnect.

2. The apparatus of claim 1, wherein the input pixel signal is to have a resolution that is greater than a supported resolution of the uncompressed video interconnect, and wherein the image encoder is to present the compressed bit stream to the uncompressed video interconnect as having the supported resolution.

3. The apparatus of claim 2, wherein the input pixel signal is to have a number of bits per pixel that equals a supported number of bits per pixel of the uncompressed video interconnect.

4. The apparatus of claim 1, wherein the input pixel signal is to have a number of bits per pixel that is greater than a supported number of bits per pixel of the uncompressed video interconnect, and wherein the image encoder is to present the compressed bit stream to the uncompressed video interconnect as having the supported number of bits per pixel.

5. The apparatus of claim 4, wherein the input pixel signal is to have a resolution that equals a supported resolution of the uncompressed video interconnect.

6. The apparatus of claim 1, wherein the image encoder is to,
conduct a compression of a pixel difference signal associated with the input pixel signal based on a value of the pixel difference signal, and
set one or more flag bits in the compressed bit stream based on the compression.

7. The apparatus of claim 6, wherein the image encoder is to discard one or more most significant bits of the pixel difference signal in response to determining that the value of the pixel difference signal is below a threshold.

8. The apparatus of claim 6, wherein the image encoder is to discard one or more least significant bits of the pixel difference signal in response to determining that the value of the pixel difference signal is above a threshold.

9. The apparatus of claim 1, wherein the uncompressed video interconnect is at least one of an HDMI interconnect, an LVDS interconnect, a V-by-One interconnect and an iDP interconnect.

10. A computer readable storage medium comprising a set of instructions which, if executed by a processor, cause a computer to:
generate a compressed bit stream based on an input pixel signal; and
send the compressed bit stream to an uncompressed video interconnect.

11. The medium of claim 10, wherein the input pixel signal is to have a resolution that is greater than a supported resolution of the uncompressed video interconnect, and wherein the instructions, if executed, cause a computer to present the compressed bit stream to the uncompressed video interconnect as having the supported resolution.

12. The medium of claim 11, wherein the input pixel signal is to have a number of bits per pixel that equals a supported number of bits per pixel of the uncompressed video interconnect.

13. The medium of claim 10, wherein the input pixel signal is to have a number of bits per pixel that is greater than a supported number of bits per pixel of the uncompressed video interconnect, and wherein the instructions, if executed, cause a computer to present the compressed bit stream to the uncompressed video interconnect as having the supported number of bits per pixel.

14. The medium of claim 13, wherein the input pixel signal is to have a resolution that equals a supported resolution of the uncompressed video interconnect.

15. The medium of claim 10, wherein the instructions, if executed, cause a computer to:
conduct a compression of a pixel difference signal associated with the input pixel signal based on a value of the pixel difference signal; and
set one or more flag bits in the compressed bit stream based on the compression.

16. The medium of claim 15, wherein the instructions, if executed, cause a computer to discard one or more most significant bits of the pixel difference signal in response to determining that the value of the pixel difference signal is above a threshold.

17. The medium of claim 15, wherein the instructions, if executed, cause a computer to discard one or more least significant bits of the pixel difference signal in response to determining that the value of the pixel difference signal is below a threshold.

18. The medium of claim 10, wherein the compressed bit stream is to be sent to at least one of an HDMI interconnect, an LVDS interconnect, a V-by-One interconnect and an iDP interconnect.

19. A receive apparatus comprising:
an uncompressed video interconnect; and
an image decoder to,
receive a compressed bit stream from the uncompressed video interconnect, and
generate an output pixel signal based on the compressed bit stream.

20. The apparatus of claim 19, wherein the image decoder is to,
establish a resolution for the output pixel signal that is greater than a supported resolution of the uncompressed video interconnect, and
establish a number of bits per pixel for the output pixel signal that equals a supported number of bits per pixel of the uncompressed video interconnect.

21. The apparatus of claim 19, wherein the image decoder is to,
establish a number of bits per pixel for the output pixel signal that is greater than a supported number of bits per pixel of the uncompressed video interconnect, and
establish a resolution for the output pixel signal that equals a supported resolution of the uncompressed video interconnect.

22. The apparatus of claim 19, wherein the image decoder is to,
read one or more flag bits in the compressed bit stream, and
decompress the compressed bit stream based on the one or more flag bits.

23. The apparatus of claim 19, wherein the uncompressed video interconnect is at least one of an HDMI interconnect, an LVDS interconnect, a V-by-One interconnect and an iDP interconnect.

24. A computer readable storage medium comprising a set of instructions which, if executed by a processor, cause a computer to:
receive a compressed bit stream from an uncompressed video interconnect; and
generate an output pixel signal based on the compressed bit stream.

25. The medium of claim 24, wherein the instructions, if executed, cause a computer to:
establish a resolution for the output pixel signal that is greater than a supported resolution of the uncompressed video interconnect; and
establish a number of bits per pixel for the output signal that equals a supported number of bits per pixel of the uncompressed video interconnect.

26. The medium of claim 24, wherein the instructions, if executed, cause a computer to:
establish a number of bits per pixel for the output pixel signal that is greater than a supported number of bits per pixel of the uncompressed video interconnect; and
establish a resolution for the output pixel signal that equals a supported resolution of the uncompressed video interconnect.

27. The medium of claim 24, wherein the instructions, if executed, cause a computer to:
read one or more flag bits in the compressed bit stream; and
decompress the compressed bit stream based on the one or more flag bits.

28. The medium of claim 24, wherein the compressed bit stream is to be received from at least one of an HDMI interconnect, and LVDS interconnect, a V-by-One interconnect and an iDP interconnect.
